(19) United States
(12) Patent Application Publication
(10) Pub. No.: US 2007/0008657 A1
(43) Pub. Date: Jan. 11, 2007

(54) Magnetic head including read head element and inductive write head element

(75) Inventors: Tetsuyuki Kubota, Kawasaki (JP); Toshinori Hoshino, Kawasaki (JP); Toshiyuki Nakada, Kawasaki (JP)

Correspondence Address: Patrick G. Burns, Esq.;GREER, BURNS & CRAIN, LTD., Suite 2500, 300 South Wacker Dr., Chicago, IL, 60606, US

(73) Assignee: FUJITSU LIMITED

(21) Appl. No.: 11/214,487

(22) Filed: Aug. 29, 2005

(30) Foreign Application Priority Data
Jul. 6, 2005 (JP) 2005-167578

(51) Int. Cl. G11B 5/33

(52) U.S. Cl. 360/313

(57) ABSTRACT

A non-magnetic layer is interposed between a read head element and an inductive write head element placed on the read head element in a magnetic head. The non-magnetic layer is made of material having a permittivity lower than that of Al₂O₃. The magnetic head of this type allows interposal of the non-magnetic layer between the read head element and the inductive write head element. Even if a sensing or writing current is supplied to the read head element or inductive write head element, the non-magnetic layer serves to avoid the leakage of the writing current as much as possible. In other words, the crosstalk current flowing to the read head element from the inductive write head element can be reduced. The read head element can be prevented from deterioration.

### BACKGROUND OF THE INVENTION

1. Field of the Invention

The present invention relates to a magnetic head including a read head element, an inductive write head element placed on the read head element, and a non-magnetic layer interposed between the read head element and the inductive write head element.

2. Description of the Prior Art

A flying head slider is usually incorporated in a hard disk drive, HDD, for example. A magnetic head is mounted on the flying head slider. The magnetic head includes a read head element and an inductive write head element placed on the read head element. A non-magnetic layer made of Al₂O₃ (alumina) is interposed between the read head element and the inductive write head element.

When magnetic bit data is to be read, a sensing current is supplied to a magnetoresistive film of the read head element through wires (hereinafter “read wires”) connected to the read head element, for example. The quantity of the sensing current is set at approximately 1 mA. On the other hand, when magnetic bit data is to be written, a writing current is supplied to a magnetic coil of the inductive write head element through wires (hereinafter “write wires”) connected to the inductive write head element, for example. The quantity of the writing current is set in a range from 40 mA to 50 mA approximately.

Electrically-conductive layers such as a lower magnetic pole layer of the inductive write head element and an upper shield layer of the read head element are placed in the space between the write wires and read wires. The electrically-conductive layers function to increase the capacitance between the write and read wires. Since the quantity of the writing current is significantly larger than that of the sensing current, the electrically-conductive layers serve to increase a so-called crosstalk current flowing to the read wires from the write wires. The increased crosstalk current leads to deterioration of the read head element.

### SUMMARY OF THE INVENTION

It is accordingly an object of the present invention to provide a magnetic head capable of suppressing the crosstalk current flowing to a read head element from an inductive write head element.

According to a first aspect of the present invention, there is provided a magnetic head comprising: a read head element; an inductive write head element placed on the read head element; and a non-magnetic layer interposed between the read head element and the inductive write head element, said non-magnetic layer being made of material having a permittivity lower than that of Al₂O₃.

The magnetic head of this type allows interposal of the non-magnetic layer between the read head element and the inductive write head element. The non-magnetic layer is made of material having a permittivity lower than that of Al₂O₃ (alumina). Even if a sensing or writing current is supplied to the read head element or inductive write head element, the non-magnetic layer serves to avoid the leakage of the writing current as much as possible. In other words, the crosstalk current flowing to the read head element from the inductive write head element can be reduced. The read head element can be prevented from deterioration.

According to a second aspect of the present invention, there is provided a lower shield layer; an insulting layer covering over the surface of the lower shield layer; an upper shield layer extending along the surface of the insulting layer; a magnetoresistive film embedded within the insulting layer between the lower and upper shield layers; wires placed to supply a sensing current to the magnetoresistive film; a non-magnetic layer formed on the upper shield layer, said non-magnetic layer made of material having a permittivity lower than that of Al₂O₃; a lower magnetic pole layer extending on the non-magnetic layer along a predetermined reference plane; a non-magnetic gap layer overlaid on the lower magnetic pole layer; an upper magnetic pole layer formed on the surface of the non-magnetic gap layer; a magnetic coil placed between the lower and upper magnetic pole layers; and wires placed to supply an electric current to the magnetic coil.

The magnetic head of this type allows interposal of the non-magnetic layer between the read head element and the inductive write head element. The non-magnetic layer is made of material having a permittivity lower than that of Al₂O₃ (alumina). Even if a sensing or writing current is supplied to the read head element or inductive write head element, the non-magnetic layer serves to avoid the leakage of the writing current as much as possible. In other words, the crosstalk current flowing to the read head element from the inductive write head element can be reduced. The read head element can be prevented from deterioration.

### BRIEF DESCRIPTION OF THE DRAWINGS

The above and other objects, features and advantages of the present invention will become apparent from the following description of the preferred embodiment in conjunction with the accompanying drawings, wherein:

FIG. 1 is a plan view schematically illustrating the inner structure of a hard disk drive (HDD) as an example of a magnetic recording medium drive;

FIG. 2 is an enlarged perspective view of a flying head slider according to a specific example;

FIG. 3 is an enlarged front view of a read/write electromagnetic transducer observed at the medium-opposed surface or an air bearing surface, ABS, of the flying head slider;

FIG. 4 is a vertical sectional view taken along the line 4-4 in FIG. 3;

FIG. 5 is a partial enlarged perspective view of the flying head slider for schematically illustrating the outflow end of the flying head slider; and

FIG. 6 is a graph showing the interrelation between relative permittivity and crosstalk.

### DESCRIPTION OF THE PREFERRED EMBODIMENT

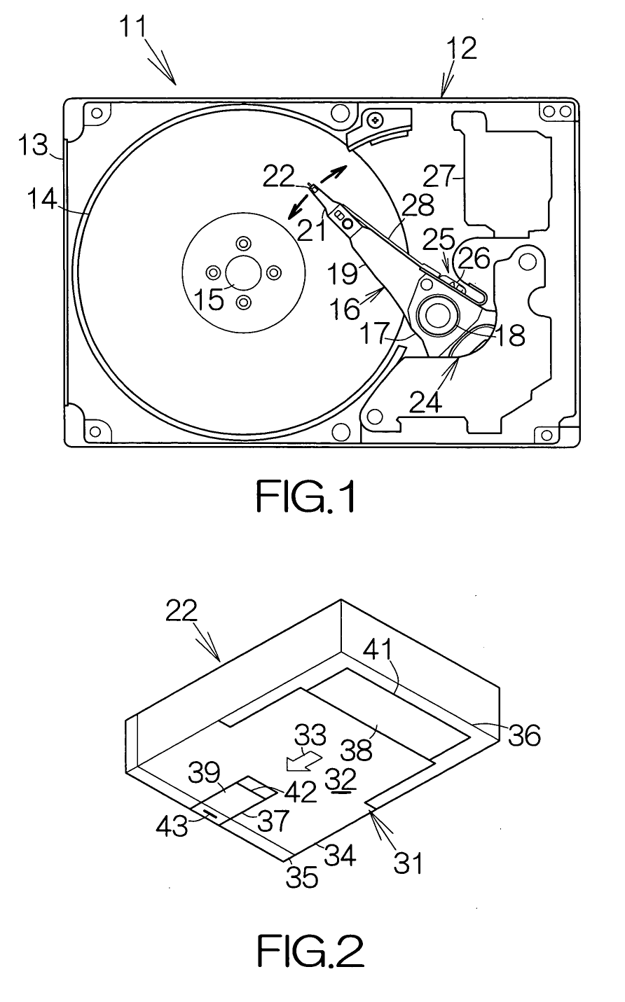

FIG. 1 schematically illustrates the inner structure of a hard disk drive, HDD, 11 as an example of a magnetic recording medium drive. The hard disk drive 11 includes a box-shaped enclosure 12. The enclosure 12 includes a boxed-shaped base 13 defining an inner space of a flat parallelepiped, for example. The base 13 may be made of a metallic material such as aluminum, for example. Molding process may be employed to form the base 13. A cover, not shown, is coupled to the base 13. The cover serves to close the opening of the inner space within the base 13. Pressing process may be employed to form the cover out of a plate material, for example.

At least one magnetic recording disk 14 as a recording medium is incorporated within the inner space of the base 13. The magnetic recording disk or disks 14 is mounted on the driving shaft of a spindle motor 15. The spindle motor 15 drives the magnetic recording disk or disks 14 at a higher revolution speed such as 5,400 rpm, 7,200 rpm, 10,000 rpm, 15,000 rpm, or the like.

A head actuator 16 is also incorporated within the inner space of the base 13. The head actuator 16 includes an actuator block 17. The actuator block 17 is supported on a vertical support shaft 18 for relative rotation. Actuator arms 19 are defined in the actuator block 17. The actuator arms 19 are designed to extend in a horizontal direction from the vertical support shaft 18. The actuator block 17 may be made of aluminum, for example. Extrusion molding process may be employed to form the actuator block 17, for example.

A head suspension 21 is attached to the front end of the individual actuator arm 19. The head suspension 21 is designed to extend forward from the corresponding front end of the actuator arm 19. A gimbal spring, not shown, is connected to the front end of the individual head suspension 21. A flying head slider 22 is fixed on the surface of the gimbal spring. The gimbal spring allows the flying head slider 22 to change its attitude relative to the head suspension 21. An electromagnetic transducer, not shown, is mounted on the flying head slider 22 as described later in detail.

When the magnetic recording disk 14 rotates, the flying head slider 22 is allowed to receive airflow generated along the rotating magnetic recording disk 14. The airflow serves to generate positive pressure or a lift and negative pressure on the flying head slider 22. The flying head slider 22 is thus allowed to keep flying above the surface of the magnetic recording disk 14 during the rotation of the magnetic recording disk 14 at a higher stability established by the balance between the urging force of the head suspension 21 and the combination of the lift and the negative pressure.

When the head actuator 16 is driven to swing around the vertical support shaft 18 during the flight of the flying head slider 22, the flying head slider 22 is allowed to move along the radial direction of the magnetic recording disk 14. This radial movement allows the electromagnetic transducer on the flying head slider 22 to cross the data zone between the innermost recording track and the outermost recording track. The electromagnetic transducer on the flying head slider 22 can thus be positioned right above a target recording track on the magnetic recording disk 14.

A power source 24 such as a voice coil motor, VCM, is coupled to the actuator block 17. The power source 24 allows the actuator block 17 to swing about the vertical support shaft 18. The swinging movement of the actuator block 17 realizes the swinging movement of the actuator arms 19 and the head suspensions 21.

As is apparent from FIG. 1, a printed circuit board or flexible printed circuit board, FPC, unit 25 is placed on the actuator block 17. A head IC (integrated circuit) or preamplifier IC 26 is mounted on the flexible printed circuit board unit 25. The preamplifier IC 26 is designed to supply the read head element of the electromagnetic transducer with a sensing current when magnetic bit data is to be read. The preamplifier IC 26 is also designed to supply the write head element included in the electromagnetic transducer with a writing current when magnetic bit data is to be written. A small-sized circuit board 27 is placed within the inner space of the base 13. The preamplifier IC 26 on the flexible printed circuit board unit 25 is designed to receive the sensing and writing currents from the circuit board 27 placed within the inner space of the enclosure 12, a printed circuit board, not shown, attached to the back surface of the bottom plate of the enclosure 12, and the like.

Flexible printed circuit boards, FPCs, 28 are utilized to supply the sensing current and the writing current. The flexible printed circuit boards 28 are related to the individual flying head sliders 22. The flexible printed circuit board 28 includes a metallic thin film such as a thin film made of a stainless steel. An insulating layer, an electrically-conductive layer and an insulating protection layer are in this sequence formed over the metallic thin film, for example. The electrically-conductive layer provides wiring patterns, not shown, extending over the flexible printed circuit board 28. The electrically-conductive layer may be made of an electrically-conductive material such as copper, for example. The insulating layer and the protection layer may be made of a resin material such as polyimide resin, for example.

The wiring patterns on the flexible printed circuit board 28 are connected to the flying head slider 22. Adhesive may be employed to fix the flexible printed circuit board 28 to the head suspension 21, for example. The flexible printed circuit board 28 extends backward along the side of the actuator arm 19 from the head suspension 21. The other end of the flexible printed circuit board 28 is connected to the flexible printed circuit board unit 25. The wiring patterns on the flexible printed circuit board 28 are connected to wiring patterns, not shown, on the flexible printed circuit board unit 25. Electrical connection is in this manner established between the flying head slider 22 and the flexible printed circuit board unit 25.

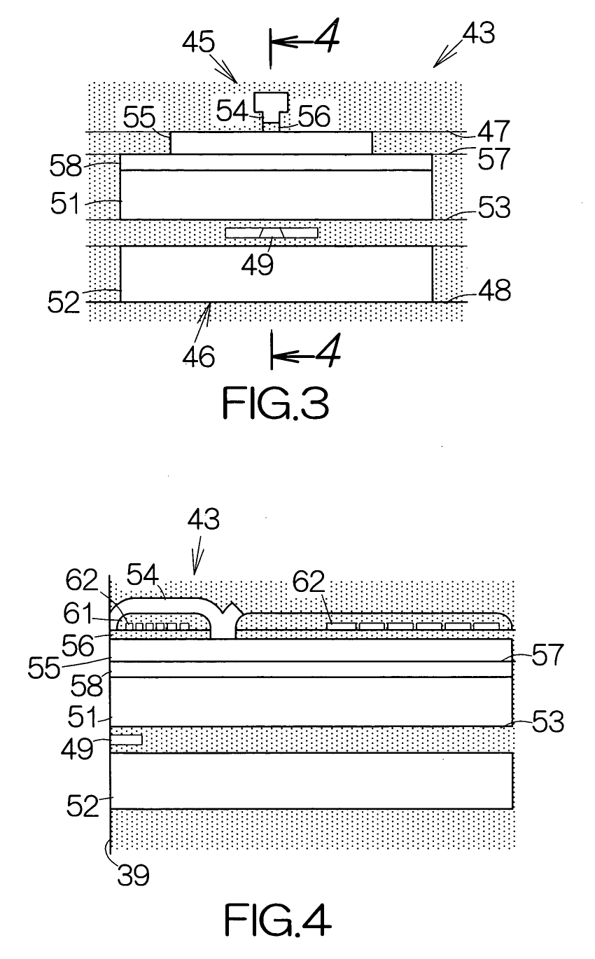

FIG. 2 illustrates a specific example of the flying head slider 22. The flying head slider 22 includes a slider body 31 in the form of a flat parallele piped. A medium-opposed surface or bottom surface 32 is defined over the slider body 31 so as to face the magnetic recording disk 14 at a distance. A flat base surface or reference surface is defined on the bottom surface 32. When the magnetic recording disk 14 rotates, airflow 33 acts on the bottom surface 32 in the direction from the inflow or front end toward the outflow or rear end of the slider body 31. The slider body 31 may comprise a base 34 made of Al₂O₃—TiC and ahead protection layer 35 made of Al₂O₃ (alumina), for example. The head protection layer 35 is overlaid on the outflow or trailing end of the base 34.

A front rail 36 and a rear rail 37 are formed on the bottom surface 32 of the slider body 31. The front rail 36 stands upright from the base surface of the bottom surface 32 near the inflow end of the slider body 31. The rear rail 37 stands upright from the base surface of the bottom surface 32 near the outflow end of the slider body 31. Air bearing surfaces, ABSs, 38, 39 are respectively defined on the top surfaces of the front and rear rails 36, 37. The inflow ends of the air bearing surfaces 38, 39 are connected to the top surfaces of the front and rear rails 36, 37 through steps 41, 42, respectively.

The bottom surface 32 of the flying head slider 22 is designed to receive airflow 33 generated along the rotating magnetic recording disk 14. The steps 41, 42 serve to generate a larger positive pressure or lift at the air bearing surfaces 38, 39. Moreover, a larger negative pressure is induced behind the front rail 36. The negative pressure is balanced with the lift so as to stably establish the flying attitude of the flying head slider 22.

The aforementioned read/write electromagnetic transducer 43 is mounted on the slider body 31. The read/write electromagnetic transducer 43 is embedded within the head protection layer 35 of the head slider body 31. The read gap and the write gap of the read/write electromagnetic transducer 43 are exposed at the air bearing surface 39 of the rear rail 37. It should be noted that the front end of the read/write electromagnetic transducer 43 may be covered with a protection layer, made of diamond-like-carbon (DLC), extending over the air bearing surface 39. The write/read electromagnetic transducer 43 will be described later in detail. The flying head slider 22 may take any shape or form other than the aforementioned one.

FIG. 3 illustrates the bottom surface 32 of the flying head slider 22 in detail. The read/write electromagnetic transducer 43 includes a thin film magnetic head or inductive write head element 45 and a read head element 46. The inductive write head element 45 allows a thin film coil to generate magnetic field in response to the supply of electric current, for example. The generated magnetic field is usually utilized to record binary data into the magnetic recording disk 14. A magnetoresistive (MR) element such as a giant magnetoresistive (GMR) element and a tunnel-junction magnetoresistive (TMR) element may be employed as the read head element 46, for example. The read head element 46 is usually allowed to induce variation in the electric resistance in response to the inversion of polarization in the applied magnetic field from the magnetic recording disk 14. This variation in the electric resistance is utilized to detect binary data.

The inductive write head 45 and the read head element 46 are interposed between an overcoat film 47 and an undercoat film 48, both made of Al₂O₃. The overcoat film 47 corresponds to the upper half of the aforementioned head protection layer 35, while the undercoat film 48 corresponds to the lower half of the head protection layer 35.

The read head element 46 includes a magnetoresistive film 49, such as a spin valve film or a tunnel-junction film, interposed between upper and lower electrically-conductive layers or upper and lower shield layers 51, 52. The magnetoresistive film 49 is embedded within an insulting layer 53 covering over the upper surface of the lower shield layer 52. The insulting layer 53 is made of Al₂O₃, for example. The upper shield layer 51 extends along the upper surface of the insulting layer 53. The upper and lower shield layers 51, 52 may be made of a magnetic material such as FeN, NiFe, or the like. A gap between the upper and lower shield layers 51, 52 serves to determine a linear resolution of magnetic recordation on the magnetic recording disk 14 along the recording track.

The inductive write head element 45 includes an electrically-conductive layers or upper and lower magnetic pole layers 54, 55. The front ends of the upper and lower magnetic pole layers 54, 55 are exposed at the air bearing surface 39. The upper and lower magnetic pole layers 54, 55 may be made of a magnetic material such as FeN, NiFe, or the like. The upper and lower magnetic pole layers 54, 55 cooperate with each other to establish a magnetic core. A non-magnetic gap layer 56 is interposed between the upper and lower magnetic pole layers 54, 55 at the air bearing surface 39. The non-magnetic gap layer 56 is made of Al₂O₃, for example. When magnetic field is generated in the magnetic coil, the magnetic flux runs between the upper and lower magnetic pole layers 54, 55. The non-magnetic gap layer 56 serves to leak the magnetic flux out of the bottom surface 32 in a conventional manner. The leaked magnetic flux forms magnetic field for recordation.

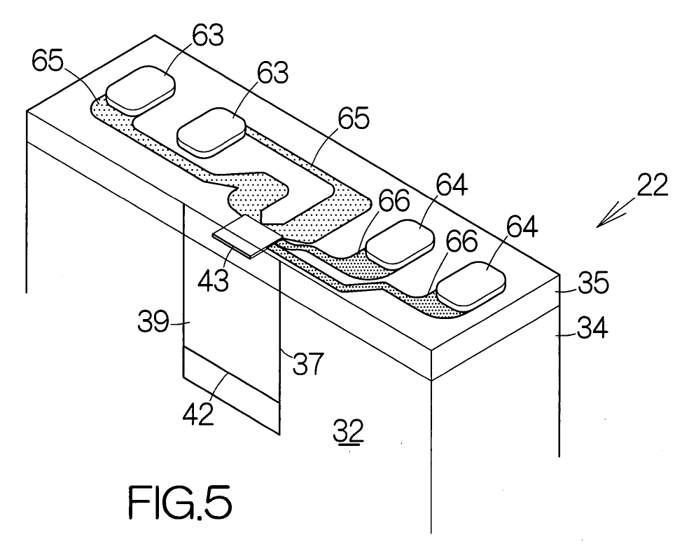

Referring also to FIG. 4, the lower magnetic pole layer 55 extends along a reference plane 57 over the upper shield layer 51. The reference plane 57 is defined on the surface of a non-magnetic layer 58. The non-magnetic layer 58 is overlaid on the upper shield layer 51 by a constant thickness. The non-magnetic layer 58 serves to establish a magnetic isolation between the upper shield layer 51 and the lower magnetic pole layer 55. The non-magnetic layer 58 may extend at least in a space between the upper shield layer 51 and the lower magnetic pole layer 55. Here, the non-magnetic layer 58 is allowed to extend along the overall upper surface of the upper shield layer 51. The non-magnetic layer 58 is made of material having a permittivity lower than that of Al₂O₃. Here, the non-magnetic layer 58 may be made of SiO₂ or a resist material such as polyimide resin, for example.

The aforementioned non-magnetic gap layer 56 is overlaid on the lower magnetic pole layer 55. A thin film coil 62 is formed on the non-magnetic gap layer 56. The magnetic coil or thin film coil 62 is embedded within an insulating layer 61. The aforementioned upper magnetic pole layer 54 is overlaid on the upper surface of the insulating layer 61. The rear end of the upper magnetic pole layer 54 is magnetically coupled with the rear end of the lower magnetic pole layer 55 at the central area of the thin film coil 62. The upper and lower magnetic pole layers 54, 55 cooperate with each other to establish a magnetic core penetrating through the central area of the thin film coil 62 in this manner.

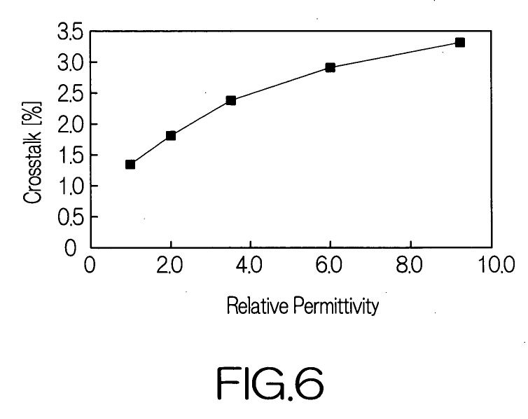

As shown in FIG. 5, two pairs of electrode terminals 63, 63, 64, 64 are placed on the outflow or trailing end surface of the flying head slider 22, namely on the surface of the head protection layer 35. The pair of electrode terminals 63, 63 is connected to a pair of wires 65, 65. The pair of electrode terminals 63, 63 is electrically connected to the read head element 46 of the read/write electromagnetic transducer 43 in this manner. The individual electrode terminal 63 is connected to the wiring pattern on the flexible printed circuit board 28. The sensing current is in this manner supplied to the magnetoresistive film 49 of the read head element 46 through the electrode terminals 63. Variation in voltage is detected from the sensing current out of the electrode terminals 63.

On the other hand, the pair of electrode terminals 64, 64 is connected to a pair of wires 66, 66. The pair of electrode terminals 64, 64 is electrically connected to the inductive write head element 45 of the read/write electromagnetic transducer 43 in this manner. The individual electrode terminal 64 is connected to the wiring pattern on the flexible printed circuit board 28. The writing current is in this manner supplied to the thin film coil 62 of the inductive write head element 45. Magnetic field is generated at the thin film coil 62 in response to the supply of the writing current. Here, the wires 65 extends across the wires 66 within the read/write electromagnetic transducer 43.

The read/write electromagnetic transducer 43 allows interposal of the non-magnetic layer 58 between the inductive write head element 45 and the read head element 46. Specifically, the non-magnetic layer 58 is interposed between the electrically-conductive layers such as the upper shield layer 51 and the lower magnetic pole layer 55. The non-magnetic layer 58 is made of material having a permittivity lower than that of Al₂O₃. The inventors demonstrates that it is possible to reduce across talk current flowing from the wires 66 to the wires 65 even if electric current is supplied to the read/write electromagnetic transducer 43 through the wires 65, 66. The read head element 46 is thus reliably prevented from deterioration.

The inventors have observed the relativity between permittivity and crosstalk based on a simulation. As shown in FIG. 6, Al₂O₃ having the relative permittivity of 9.3 approximately realizes the crosstalk current equal to 3.3[%] approximately of the writing current. SiO₂ having the relative permittivity of 4.0 approximately realizes the crosstalk current equal to 2.5[%] approximately of the writing current. Polyimide resin having the relative permittivity of 3.5 approximately realizes the crosstalk current equal to 2.4[%] approximately of the writing current. It was demonstrated that the non-magnetic layer 58 of the aforementioned type serves to reduce the crosstalk current as compared with Al₂O₃.

Otherwise, the non-magnetic layer 58 may include a section made of Al₂O₃ extending between the upper shield layer 51 and the lower magnetic pole layer 55, and a section made of SiO₂, for example. Alternatively, the non-magnetic layer 58 may include a section made of Al₂O₃ extending between the upper shield layer 51 and the lower magnetic pole layer 55, and a resist material such as polyimide resin. The sections may be arranged based on a meshed pattern.

The non-magnetic layer 58 of the aforementioned type serves to reduce the crosstalk current due to the material having a permittivity lower than that of Al₂O₃. Moreover, the mixed Al₂O₃ serves to realize a sufficient strength of the non-magnetic layer 58. Even if sputtering is employed to form the lower and upper magnetic pole layers 55, 54 over the non-magnetic layer 58, the upper surface of the non-magnetic layer 58 can reliably be kept flat. The inductive write head element 45 can be formed on the flat upper surface of the non-magnetic layer 58 in an accurate shape.

What is claimed is:

1. A magnetic head comprising:
a read head element;
an inductive write head element placed on the read head element; and
a non-magnetic layer interposed between the read head element and the inductive write head element, said non-magnetic layer being made of material having a permittivity lower than that of Al₂O₃.

2. A magnetic head comprising:
a lower shield layer;
an insulting layer covering over a surface of the lower shield layer;
an upper shield layer extending along a surface of the insulting layer;
a magnetoresistive film embedded within the insulting layer between the lower and upper shield layers;
wires placed to supply a sensing current to the magnetoresistive film;
a non-magnetic layer formed on the upper shield layer, said non-magnetic layer made of material having a permittivity lower than that of Al₂O₃;
a lower magnetic pole layer extending on the non-magnetic layer along a predetermined reference plane;
a non-magnetic gap layer overlaid on the lower magnetic pole layer;
an upper magnetic pole layer formed on a surface of the non-magnetic gap layer;
a magnetic coil placed between the lower and upper magnetic pole layers; and
wires placed to supply an electric current to the magnetic coil.
